(19) United States
(12) Patent Application Publication
(10) Pub. No.: US 2018/0349827 A1
(43) Pub. Date: Dec. 6, 2018

(54) Apparatus And Method For Asset Benchmarking

(71) Applicant: General Electric Company, Schenectady, NY (US)

(72) Inventors: John Slovensky, Roanoke, VA (US); Sarah Lukens, Roanoke, VA (US); Jason Cline, Roanoke, VA (US); Henri Pijcke, Roanoke, VA (US); Manjish Naik, Roanoke, VA (US)

(21) Appl. No.: 15/608,789

(22) Filed: May 30, 2017

(51) Int. Cl. G06Q 10/06; G06Q 10/10; G06Q 30/02; G06Q 50/04

(52) U.S. Cl. CPC G06Q 10/06393; G06Q 10/0637; G06Q 50/04; G06Q 30/0201; G06Q 10/10

(57) ABSTRACT

A mapping is automatically created based upon first data records, and the mapping links customer equipment names found in the first data set to selected universal equipment names. The mapping is subsequently refined based upon a review. Using the mapping, customer equipment names found in second data records are automatically mapped to selected universal equipment names. An analytic determines a first metric for a selected first equipment of a first customer and a second metric for a second equipment of a second customer. A comparison of the first metric and the second metric is presented. The comparison is valid because of the mapping.

### BACKGROUND OF THE INVENTION

### Field of the Invention

The subject matter disclosed herein generally relates to the operation of industrial machines and, more specifically, to comparing the operation of different industrial machines.

### Brief Description of the Related Art

Industrial machines of different types are used at various locations and provide a large number of functions. For example, different types of industrial machines (e.g., grinders, saws, and drill presses) are used in factories. Other types of industrial machines such as windmills or reactors produce energy. Still other types of machines (e.g., heaters, boilers, and refrigeration units) provide for environmental control of different areas or spaces. Yet other types of machines such as trucks or other vehicles provide transportation services.

Various types of metrics or benchmarks describe the operation of these machines. For example, a mean time between failures metric describes the average time between one failure and another failure of the machine. Other types of metrics describe or are associated with the maintenance costs associated with a machine, the availability of the machine, the downtime of the machine, and the effectiveness of the machine. Other types of metrics are possible.

Users of machines typically desire to compare the operation of their machine to other machines of the same type. In this way, the user can determine if their machine is operating properly and can take corrective actions if required.

In today's industrial environments, hundreds, thousands, and even millions of machines exist. Various data used to calculate the metrics is consumed by analytics, which then calculate a particular metric associated with a particular machine.

The data for a particular machine is identified by a machine-type label or identifier. Unfortunately, different users utilize different names to identify the same type of machines. It has become extremely difficult to make valid metric comparisons between machines of the same type since the amount of data and the amount of possible names created by users is virtually limitless. It is also almost impossible to know what different users (e.g., located in different countries or using different languages) might call an asset. Some users have attempted to manually match machines of the same type so that comparisons can be done, but this is a huge task and is susceptible to human error.

### BRIEF DESCRIPTION OF THE INVENTION

Generally speaking, the present invention provides systems and methods for automatically and dynamically allowing users to compare metrics between machines of the same type no matter how the machines have been named by the owner or operator of the machine. These approaches utilize machine learning algorithms to dynamically create and fine-tune mappings, which are then used to map disparate equipment names (used by users, owners, or operators of the machines) to universal equipment names. Consequently, metrics for machines having the same universal equipment name can be legitimately compared since the machines are of the same type.

In many of these embodiments, first data records from multiple users are received. A mapping is automatically created based upon the first data records, and the mapping links customer equipment names found in the first data set to selected universal equipment names. The mapping is subsequently refined based upon a review.

Second data records are then received from the multiple users. Using the mapping, customer equipment names found in the second data records are automatically mapped to selected universal equipment names. An analytic determines a first metric for a selected first equipment of a first customer and a second metric for a second equipment of a second customer. The selected first equipment and the second equipment have been identified as being of the same equipment type according to the mapping.

A comparison of the first metric and the second metric is presented. The comparison is valid because of the mapping.

In some aspects, the review is a manual review. In other aspects, the review is at least partially automated.

In some examples, the type is associated with an equipment or model type, a service type, an event type, a failure type, or a failure event type. In other examples, the first data records and the second data records are spreadsheets or work orders.

In examples, the mapping is accomplished by utilizing (at least partially) a manual process. In still other examples, the comparison is presented to a user in real time.

In others of these embodiments, an apparatus includes an interface, a data storage device, and a control circuit. The interface includes an input and an output, and the input is configured to receive first data records from multiple users. The data storage device stores an analytic.

The control circuit is coupled to the interface and the data storage device. The control circuit is configured to automatically create a mapping based upon the first data records. The mapping is a data structure that links customer equipment names found in the first data set to selected universal equipment names. The control circuit stores the mapping in the data storage device. The mapping is subsequently refined based upon a review.

Second data records are received from the multiple users at the input of the interface. The control circuit is further configured to retrieve the mapping and, according to the mapping, automatically map customer equipment names found in the second data records to selected universal equipment names. The control circuit is configured to determine by executing the analytic a first metric for a selected first equipment of a first customer and a second metric for a second equipment of a second customer. The selected first equipment and the second equipment are identified as of the same type by the mapping. The control circuit is configured to present a comparison of the first metric and the second metric at the output of the interface. The comparison is valid because of the mapping.

In examples, the review is a manual review by a user and the user inputs or enters instructions to modify the mapping via the input of the interface. In other examples, the review is performed by the control circuit.

In aspects, the type is or is associated with an equipment or model type, a service type, an event type, a failure type, or a failure event type. Other examples are possible.

In examples, the first data records and the second data records are spreadsheets or work orders. In other examples, the mapping is accomplished by at least partially utilizing a manual process. In aspects, the comparison is presented to a user in real time via the output of the interface.

### BRIEF DESCRIPTION OF THE DRAWINGS

For a more complete understanding of the disclosure, reference should be made to the following detailed description and accompanying drawings wherein:

FIG. 1 comprises a block diagram of a system that allows the comparison of metrics from different industrial machines according to various embodiments of the present invention;

FIG. 2 comprises a flowchart of an approach that allows the comparison of metrics from different industrial machines according to various embodiments of the present invention;

FIG. 3 comprises a clock diagram of an apparatus that allows the comparison of metrics from different industrial machines according to various embodiments of the present invention;

FIG. 4 comprises a diagram of mapping structures according to various embodiments of the present invention;

FIG. 5 comprises a screen shot of one example of a comparison that be rendered to a user, the comparison being of metrics from different industrial machines according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

Generally speaking, the present invention provides systems and methods for automatically and dynamically allowing users to compare metrics between machines of the same type no matter how the machines have been named by the owner, operator, or user of the machines. These approaches utilize machine learning algorithms to dynamically create and fine-tune mappings, which are used to map disparate equipment names chosen by users, owners, or operators of the machines to universal equipment names. Metrics can be obtained from analytics for known same-type machines, and these metrics usefully compared to provide value to a user.

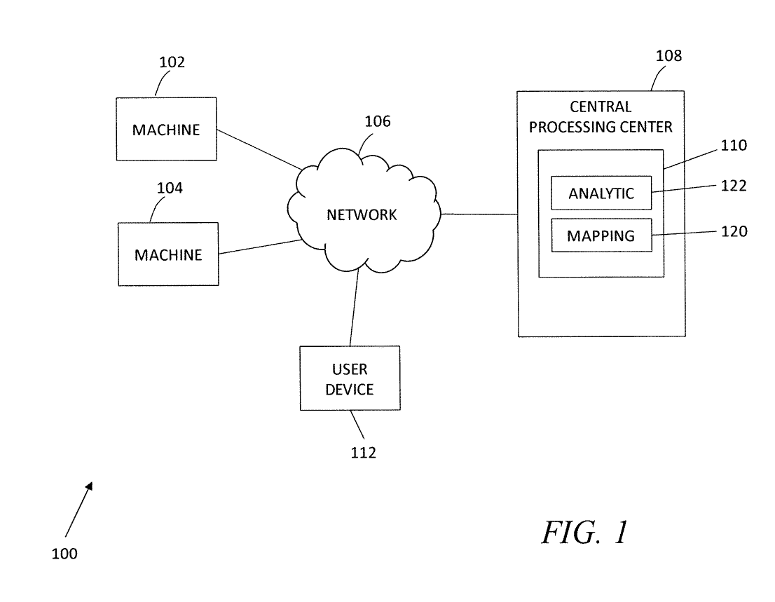

Referring now to FIG. 1, one example of a system that provides for the meaningful comparison of metrics of different industrial machines of the same type is described. The system 100 includes a first industrial machine (or equipment) 102, a second industrial machine (or equipment) 104, a network 106, and a central processing center 108 (with an apparatus 110). A user device 112 is coupled to the network 106.

The first industrial machine 102 and the second industrial machine 104 may be any type of machine such as different types of factory or production-line machines (e.g., grinders, saws, and drill presses). The machines 102 and 104 may also be machines that produce or gather energy such as windmills or reactors, that provide for the environmental control of different areas or spaces (e.g., heaters, boilers, and refrigeration units), or that provide transportation services (e.g., trucks, airplanes, ships, cars, or other vehicles). Other examples of industrial machines are possible. The machines 102 and 104 may be of the same type or different type. Additionally, the machines 102 and 104 may be owned or operated by the same user or by different users.

The industrial machines 102 and 104 are machines that perform industrial or infrastructure functions, and which have failures and require maintenance. These machines may be deployed at various locations such as factories, schools, office buildings, campus, or they may be mobile. Other examples of installations are possible.

The network 106 may be any network or combination of networks. In examples, the network 106 may be the cloud, the internet, cellular networks, local or wide area networks, or any combination of these (or other) networks. The network 106 may include various electronic devices (e.g., routers, gateways, and/or processors to mention a few examples).

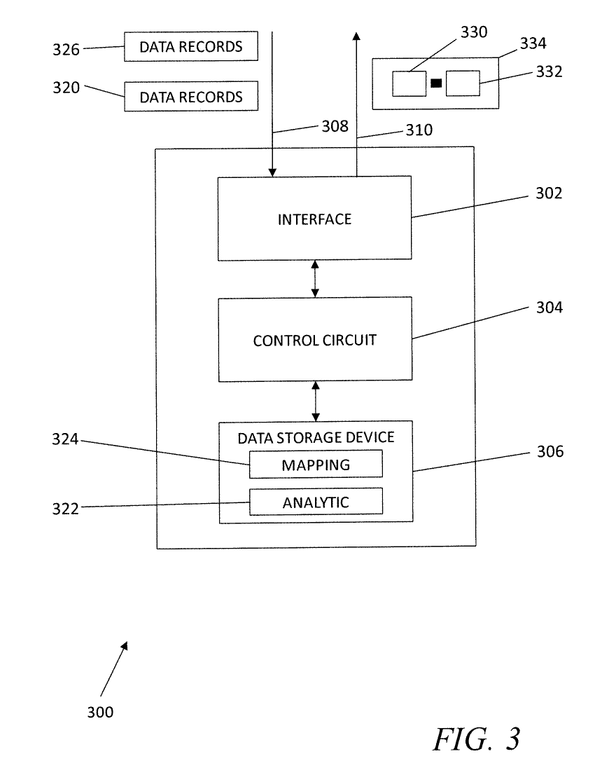

The central processing center 108 includes the apparatus 110, which creates and refines the mapping based upon data records received from the machines 102 and 104. The apparatus 110 may include an interface, database, and control circuit. In aspects, the apparatus 110 may be implemented as apparatus 300 shown in FIG. 3.

The user device 112 may be any device that is capable of displaying information to a user. In examples, the apparatus 112 is a smartphone, a personal computer, a tablet, or a laptop. The user device 112 may be mobile (e.g., it may move within the installations in which the machines 102 and 104 are deployed) or it may be deployed permanently at one location (e.g., as a personal computer at the central processing center 108).

In one example of the operation of the system of FIG. 1, first data records from multiple users are received. In this example, the machine 102 is owned or operated by a first user and the machine 104 is owned or operated by a second user. The first data records are sent from the machines 102 and 104, over the network 106, and received by the apparatus 110 at the central processing center 108. A mapping 120 is automatically created by the apparatus 110 based upon the first data records, and the mapping links customer equipment names found in the first data records to selected universal equipment names.

The mapping 120 is subsequently refined based upon a review. The review may be performed by a user at the user device 112. For example, a suggested mapping may be displayed on a screen at the user device 112. This display may include suggestions, but some mappings may be left blank for the user to enter a mapping. In other aspects, the review is at least partially automated, for example, by using an algorithm that is executed by the apparatus 110.

Second data records are then received from the machines 102 and 104. Using the mapping 120, customer equipment names found in the second data records are automatically mapped by the apparatus 110 to selected universal equipment names. Mappings that already exist and that have been confirmed by a user (as described above) may be left unaltered.

The user may select a machine of a predetermined type and wish to compare metrics of the machine to metrics of other machines of the same type. In these regards, an analytic 122 deployed at the central processing center 108 (e.g., at the apparatus 110) determines a first metric for a selected first equipment of a first customer, and a second metric for a second equipment of a second customer. The analytic 122 may, in aspects, be a computer program that calculates a specific metric (e.g., mean time between failures) based upon inputs received from the data records. The selected first equipment (in this example, machine 102) and the second equipment (in this example, the machine 104) are identified as being of the type according to the mapping 120. In some examples, the type is or is associated with an equipment type, a service type, an event type, a failure type, or a failure event type. Other examples are possible.

A comparison of the first metric and the second metric is presented to the user at the user device 112 from information received from the apparatus 110. The comparison is valid because of the mapping. In aspects, the comparison is presented to a user at the user device 112 in real time.

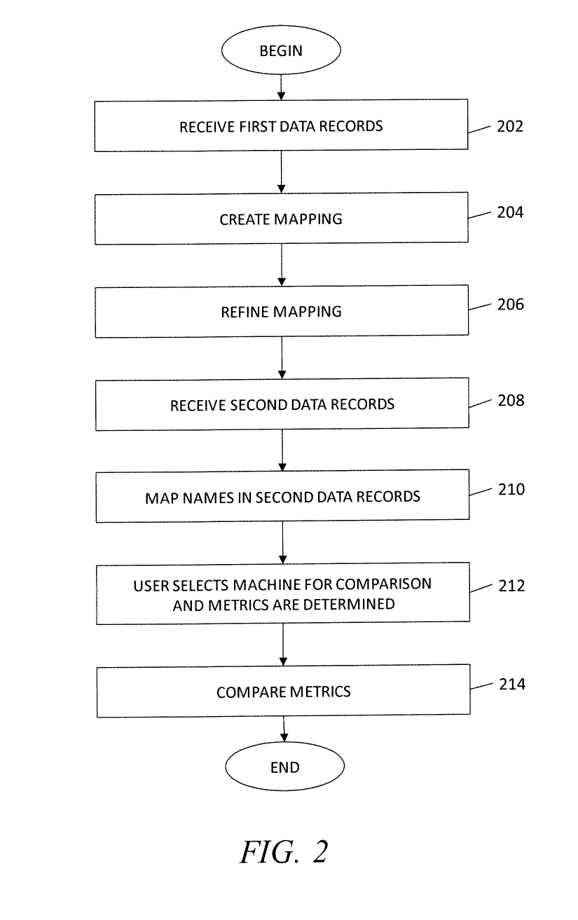

Referring now to FIG. 2, one example of an approach for meaningfully comparing metrics of different machines of the same type is described. At step 202, first data records from multiple users are received. In aspects, the data records are spread sheets or work orders. Other examples are possible.

At step 204, a mapping is automatically created based upon the first data records, and the mapping links customer equipment names found in the first data set to selected universal equipment names. The mapping may be performed or created by a machine learning algorithm. In this case, a machine learning algorithm determines the algorithm used to produce the mapping. Training data (e.g., the first data records in the examples described herein) is provided and used to produce the mapping algorithm, which, in turn, creates a mapping data structure. In aspects, a supervised machine learning approach is used where example inputs and their desired outputs are provided to learn a general rule that maps inputs to outputs thereby creating a mapping algorithm. in other words, machine learning algorithms produce the mappings without being explicitly programmed to do so, and can change or be refined over time as new data is received.

In examples, suggestions can be generated as to a correct mapping. For example, ensemble modeling of multiple string distance algorithms as applied against a new item to map can be used. These approaches correctly map obvious choices leaving only a few non-obvious elements to be manually mapped by a user. Suggestions of possible mappings may be offered to the user based upon past mappings. Given identical input, the mapping algorithm always produces the same suggestions. Scalability is also provided since the quality and accuracy of the mappings improve over time and require less and less time to review.

At step 206, the mapping is subsequently refined based upon a review. In one aspect, a user manually reviews the mapping on the screen of a user device. In other examples, an automated review of the mapping is performed. For example, preprogrammed rules may be applied to the mapping and changes made to the mapping based upon the results of the application of these rules.

At step 208, second data records are then received from the multiple users. In the examples, the second data records may be work orders or spread sheets.

At step 210 and using the mapping, customer equipment names found in the second data records are automatically mapped to selected universal equipment names. A machine learning algorithm may be utilized to perform the mapping. Mappings that already exist and that have been confirmed by a user (as described above) may be left unaltered. Further refinement of the mapping can also be made.

At step 212, the user selects a machine or equipment of a predetermined type and wishes to compare metrics of the machine to metrics of other machines of the same type. An analytic determines a first metric for selected first equipment (e.g., of a first customer) and a second metric for second equipment (e.g., of a second customer). The selected first equipment and the second equipment have been identified as being of the same equipment type according to the mapping.

The data records relating to the first equipment and the second equipment include the identity of the first customer and the second customer, and information used to calculate a metric. This information (from each record) is used by the analytic to calculate a first metric for the first equipment and a second metric for the second equipment. Since the first equipment and the second equipment have been identified by the mapping as being of the same type, a comparison of the metrics will be valid, valuable, useful, and meaningful. By valid, valuable, useful and meaningful it is meant that a user sees or obtains value in the comparison, and can take the additional steps or actions (e.g., repairing the machine, scheduling the machine for maintenance, deactivating the machine, changing a part on the machine) based upon an evaluation of the comparison (e.g., determining how close one machine is operating relative to another machine). These actions allow the equipment (or any process used by the equipment) to be run more efficiently, and reduce down time of the machine, thereby increasing the profitability of the equipment (or the process associated with the equipment).

At step 214, a comparison of the first metric and the second metric is presented to a user. The comparison is valid because of the mapping.

Referring now to FIG. 3, an apparatus that provides for the meaningful comparisons of metrics for different machines is described. The apparatus 300 includes an interface 302, a data storage device 304, and a control circuit 306.

The interface 302 includes an input 308 and an output 310. The input 308 is configured to receive first data records 320 from multiple users. The data storage device 304 stores an analytic 322. The data storage device 304 may be any type of computer or electronic memory.

The control circuit 306 is coupled to the interface 302 and the data storage device 304. The control circuit 306 may be any combination of electronic hardware or software that implements the functions described herein. In one example, the control circuit is a microprocessor that executes computer instructions.

The control circuit 306 is configured to automatically create a mapping 324 based upon the first data records. The mapping 324 is a data structure that links customer equipment names found in the first data set to selected universal equipment names. The control circuit 306 stores the mapping 324 in the data storage device 304. The mapping 324 is subsequently refined based upon a review.

Second data records 326 are received from the multiple users at the input 308 of the interface 302. The control circuit 306 is further configured to retrieve the mapping 324 and, according to the mapping 324, automatically map customer equipment names found in the second data records 326 to selected universal equipment names.

A user selects a machine or equipment of a predetermined type and wishes to compare metrics of the machine to metrics of other machines of the same type. The control circuit 306 is still further configured to determine by executing the analytic 322 a first metric 330 for a user-selected first equipment of a first customer and a second metric 332 for a second equipment of a second customer. The selected first equipment and the second equipment are identified as of the same type by the mapping. The control circuit 306 is additionally configured to present a comparison 334 of the first metric 330 and the second metric 332 at the output 310 of the interface 302. The comparison 334 is valid because of the mapping 324.

In examples, the review is a manual review by a user and the user inputs instructions to modify the mapping via the input 308 of the interface 302. In other examples, the review is performed by the control circuit 306.

In aspects, the type is or is associated with an equipment or model type (e.g., a heater or boiler), a service type, an event type (a failure), a failure type (e.g., component failure), or a failure event type (e.g., critical failure). Other examples are possible.

In examples, the first data records 320 and the second data records 326 are spreadsheets or work orders. In other examples, the mapping 324 is accomplished by at least partially utilizing a manual process. In aspects, the comparison 334 is presented to a user in real time via the output of the interface.

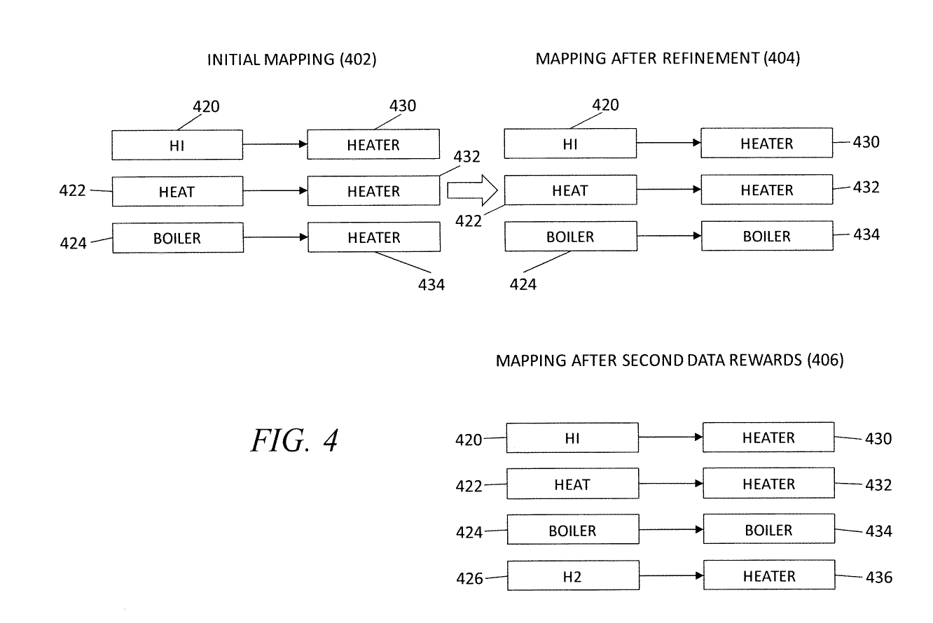

Referring now to FIG. 4, examples of mapping data structures and how these structures change over time are described. An initial mapping 402 is shown after a first set of data records is received. A second mapping 404 is shown after a user refinement is performed. A third mapping 406 is shown after a second set of data records is received. It will be appreciated that these mappings are data structures. Any type of data structure can be used such as a look-up table, or linked lists. Other examples of data structures are possible.

The first mapping 402 includes customer equipment names 420 (“H1”), 422 (“HEAT”), and 424 (“BOILER”). These are mapped to universal equipment names 430, 432, and 434 (all being “HEATER”).

The second mapping 404 results from a manual user review (or automatic review) of the first mapping 402. For example, a user may be presented with the mapping 402 on a screen (e.g., on mobile or fixed electronic device) and the user manually reviews the mapping 402. In this case, the user believes the mapping from customer equipment name 420 to universal equipment name 430 is correct. Similarly, the user believes the mapping from customer equipment name 422 to universal equipment name 432 is correct. However, the user believes the mapping from customer equipment name 424 to universal equipment name 434 is incorrect. More specifically, the user believes that “BOILER” should not be mapped to “HEATER,” but should be mapped to “BOILER.” The user manually changes the universal equipment name 434 to “BOILER” so that this mapping is correct.

The third mapping 406 includes the mappings from the second mapping 404, but also adds a mapping from customer equipment name 426 (“HT2”) to universal equipment name 436 (“HEATER”). A user may subsequently confirm that this mapping is accurate (or an automatic confirmation may be generated).

The learning algorithm (that is used to produce the mappings) may initially have rules that specify any term beginning with “H,” “HEAT,” or that includes the term “HEATER” is mapped to “HEATER.” The algorithm is changed later when it learns (and the user may confirm) that a name beginning with “HT” is also a “HEATER.” Subsequently, any elements beginning with “HT” will be mapped as “HEATER.”

A user selects a machine or equipment of a predetermined type and wishes to compare metrics of the machine to metrics of other machines of the same type. In this example, the user may select “HEATER” and view metrics for all (or a subset) of machines of type “HEATER.”

Thus, these approaches correctly map obvious choices leaving only a few non-obvious elements to be manually mapped by a user. Scalability is also provided since the quality and accuracy of the mappings improve over time and require less and less time for a user to review.

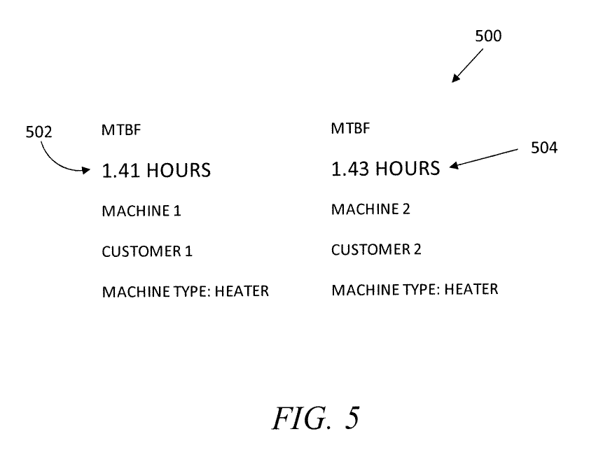

Referring now to FIG. 5, one example of a comparison 500 that is presented or rendered visually to a user is described. The comparison 500 in this example may be rendered on a graphic display of a user device such as a smartphone, personal computer, tablet, or laptop.

A user selects a machine or equipment of a predetermined type and wishes to compare metrics of the machine to metrics of other machines of the same type. In this case, the user requests the comparison 500. The comparison 500 includes a first metric 502 from a first machine and a second metric 504 from a second machine. The metrics 502, 504 may be generated from information received in data records from the machines. In this example the metrics 502, 504 are mean time between failures of the machines. The information used to calculate each metric may be information obtained in work orders such as the last time the machines were repaired, the components repaired, and the time needed to repair the machine.

The metrics 502 and 504 are conveniently displayed side-by-side. Since the machines are of the same type, the metrics can be used to make a valid comparison. For example and in this case, the metrics indicate mean time between failures are very close together. This may inform the user that their machine (the first machine) is operating properly and that no further actions are required at this time. On the other hand, if the numbers were far off, the user may feel the need to take a further action. In other aspects, the actions may be automatically taken or accomplished.

It will be appreciated by those skilled in the art that modifications to the foregoing embodiments may be made in various aspects. Other variations clearly would also work, and are within the scope and spirit of the invention. It is deemed that the spirit and scope of the invention encompasses such modifications and alterations to the embodiments herein as would be apparent to one of ordinary skill in the art and familiar with the teachings of the present application.

What is claimed is:

1. A method, comprising:
receiving first data records from multiple users;
automatically creating a mapping based upon the first data records, the mapping linking customer equipment names found in the first data records to selected universal equipment names;
subsequently refining the mapping based upon a user review of the mapping;
receiving second data records from the multiple users;
using the mapping, automatically mapping customer equipment names found in the second data records to selected ones of the universal equipment names;
determining by an analytic a first metric for a selected first equipment of a first customer and a second metric for a second equipment of a second customer, the selected first equipment and the second equipment being identified as of the same type by the mapping;
presenting a comparison of the first metric and the second metric the first metric, the comparison being valid because of the mapping.

2. The method of claim 1, wherein the review is a manual review.

3. The method of claim 1, wherein the review is at least partially automated.

4. The method of claim 1, wherein the type is or is associated with an equipment or model type, a service type, an event type, a failure type, or a failure event type.

5. The method of claim 1, wherein the first data records and the second data records are spreadsheets or work orders.

6. The method of claim 1, wherein the mapping is accomplished by utilizing at least partially a manual process.

7. The method of claim 1, wherein the comparison is presented to a user in real time.

8. An apparatus, the apparatus comprising:
an interface with an input and an output, the input configured to receive first data records from multiple users;
a data storage device storing an analytic;
a control circuit coupled to the interface and the data storage device, the control circuit configured to automatically create a mapping based upon the first data records, the mapping being a data structure that links customer equipment names found in the first data records to selected universal equipment names, the control circuit storing the mapping in the data storage device, wherein the mapping is subsequently refined based upon a review,
wherein second data records are received from the multiple users at the input of the interface;
wherein the control circuit is further configured to retrieve the mapping and, according to the mapping, automatically map customer equipment names found in the second data records to selected universal equipment names, the control circuit configured to determine by executing the analytic a first metric for a selected first equipment of a first customer and a second metric for a second equipment of a second customer, the selected first equipment and the second equipment being identified as of the same type by the mapping, the control circuit configured to present a comparison of the first metric and the second metric at the output of the interface, the comparison being valid because of the mapping.

9. The apparatus of claim 8, wherein the review is a manual review by a user and the user inputs instructions to modify the mapping via the input of the interface.

10. The apparatus of claim 8, wherein the review is performed by the control circuit.

11. The apparatus of claim 8, wherein the type is or is associated with an equipment or model type, a service type, an event type, a failure type, or a failure event type.

12. The apparatus of claim 8, wherein the first data records and the second data records are spreadsheets or work orders.

13. The apparatus of claim 8, wherein the mapping is accomplished by at least partially utilizing a manual process.

14. The apparatus of claim 8, wherein the comparison is presented to a user in real time via the output of the interface.
